(19) United States
(12) Patent Application Publication
(10) Pub. No.: US 2026/0246951 A1
(43) Pub. Date: Aug. 20, 2026

(54) INTRA-BLOCK COPY WITH SUBBLOCK MODES AND TEMPLATE MATCHING

(71) Applicant: MEDIATEK INC., Hsinchu City (TW)

(72) Inventors: Chen-Yen LAI, Hsinchu City (TW); Yu-Cheng LIN, Hsinchu City (TW); Chih-Hsuan LO, Hsinchu City (TW); Man-Shu CHIANG, Hsinchu City (TW); Ching-Yeh CHEN, Hsinchu City (TW); Tzu-Der CHUANG, Hsinchu City (TW); Chih-Wei HSU, Hsinchu City (TW); Yi-Wen CHEN, San Jose, CA (US); Yu-Wen HUANG, Hsinchu City (TW)

(21) Appl. No.: 19/472,121

(22) PCT Filed: Apr. 12, 2024
(86) PCT No.: PCT/CN2024/087524

§ 371 Date: Oct. 3, 2025

Related U.S. Application Data
(60) Provisional application No. 63/495,586, filed on Apr. 12, 2023.
(60) Provisional application No. 63/495,587, filed on Apr. 12, 2023.
(60) Provisional application No. 63/496,981, filed on Apr. 19, 2023.

(51) Int. Cl. H04N 19/176; H04N 19/105; H04N 19/132; H04N 19/52; H04N 19/54

(52) U.S. Cl. CPC H04N 19/176; H04N 19/105; H04N 19/132; H04N 19/52; H04N 19/54

(57) ABSTRACT

A method for coding blocks using subblock-based intra block copy (IBC) is provided. A video coder receives data to be encoded or decoded as a current block of pixels of a current picture of a video. The video coder selects a prediction candidate from a list of prediction candidates. A first prediction candidate in the list of prediction candidates provides a plurality of vectors that respectively reference a plurality of sets of pixels in the current picture as predictors for a plurality of subblocks of the current block. The video coder encodes or decodes the current block using the selected prediction candidate. The video coder may signal or receive a skip mode indication for determining whether a residual for the current block is signaled and used for encoding or decoding the current block.

### CROSS REFERENCE TO RELATED PATENT APPLICATION(S)

The present disclosure is part of a non-provisional application that claims the priority benefit of U.S. Provisional Patent Application Nos. 63/495,586, 63/495,587, and 63/496,981 filed on 12 Apr. 2023, 12 Apr. 2023, and 19 Apr. 2023, respectively. Contents of above-listed applications are herein incorporated by reference.

### TECHNICAL FIELD

The present disclosure relates generally to video coding. In particular, the present disclosure relates to methods of coding pixel blocks by intra-block copy mode, subblock mode, and template matching techniques.

### BACKGROUND

Unless otherwise indicated herein, approaches described in this section are not prior art to the claims listed below and are not admitted as prior art by inclusion in this section.

High-Efficiency Video Coding (HEVC) is an international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block of pixels, and each CU can be recursively split into four smaller CUs until the predefined minimum size is reached. Each CU contains one or multiple prediction units (PUs).

Versatile video coding (VVC) is the latest international video coding standard developed by the Joint Video Expert Team (JVET) of ITU-T SG16 WP3 and ISO/IEC JTC1/SC29/WG11. The input video signal is predicted from the reconstructed signal, which is derived from the coded picture regions. The prediction residual signal is processed by a block transform. The transform coefficients are quantized and entropy coded together with other side information in the bitstream. The reconstructed signal is generated from the prediction signal and the reconstructed residual signal after inverse transform on the de-quantized transform coefficients. The reconstructed signal is further processed by in-loop filtering for removing coding artifacts. The decoded pictures are stored in the frame buffer for predicting the future pictures in the input video signal.

In VVC, a coded picture is partitioned into non-overlapped square block regions represented by the associated coding tree units (CTUs). The leaf nodes of a coding tree correspond to the coding units (CUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors and reference indices to predict the sample values of each block. A predictive (P) slice is decoded using intra prediction or inter prediction with at most one motion vector and reference index to predict the sample values of each block. An intra (I) slice is decoded using intra prediction only.

A CTU can be partitioned into one or multiple non-overlapped coding units (CUs) using the quadtree (QT) with nested multi-type-tree (MTT) structure to adapt to various local motion and texture characteristics. A CU can be further split into smaller CUs using one of the five split types: quad-tree partitioning, vertical binary tree partitioning, horizontal binary tree partitioning, vertical center-side triple-tree partitioning, horizontal center-side triple-tree partitioning.

Each CU contains one or more prediction units (PUs). The prediction unit, together with the associated CU syntax, works as a basic unit for signaling the predictor information. The specified prediction process is employed to predict the values of the associated pixel samples inside the PU. Each CU may contain one or more transform units (TUs) for representing the prediction residual blocks. A transform unit (TU) is comprised of a transform block (TB) of luma samples and two corresponding transform blocks of chroma samples and each TB correspond to one residual block of samples from one color component. An integer transform is applied to a transform block. The level values of quantized coefficients together with other side information are entropy coded in the bitstream. The terms coding tree block (CTB), coding block (CB), prediction block (PB), and transform block (TB) are defined to specify the 2-D sample array of one-color component associated with CTU, CU, PU, and TU, respectively. Thus, a CTU consists of one luma CTB, two chroma CTBs, and associated syntax elements. A similar relationship is valid for CU, PU, and TU.

For each inter-predicted CU, motion parameters consisting of motion vectors, reference picture indices and reference picture list usage index, and additional information are used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU. The alternative to merge mode is the explicit transmission of motion parameters, where motion vector, corresponding reference picture index for each reference picture list and reference picture list usage flag and other needed information are signalled explicitly per each CU.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the disclosure provide a method for coding pixel blocks using subblock-based intra block copy (IBC). A video coder receives data to be encoded or decoded as a current block of pixels of a current picture of a video. The video coder selects a prediction candidate from a list of prediction candidates. A first prediction candidate in the list of prediction candidates provides a plurality of vectors that respectively reference a plurality of sets of pixels in the current picture as predictors for a plurality of subblocks of the current block. The video coder encodes or decodes the current block using the selected prediction candidate.

In some embodiments, the list of prediction candidates may be a list that is specialized for subblock-based IBC modes, such that the list includes two or more merge candidates that provide predictors for the subblocks of the current block by referencing pixels of the current picture. The video coder may select the prediction candidate by signaling an index for selecting a candidate in the list of prediction candidates (e.g., ibc_sublk_merge_idx), if a flag (e.g., ibc_sublk_flag) for enabling subblock-based IBC is also signaled.

In some embodiments, to implement IBC-sbTMVP mode, one of the prediction candidates in the list provides a block vector that is used to derive motion shift for each subblock of the current block. The motion information of the subblocks of the current block are derived from motion information of corresponding blocks located by the block vector without temporal scaling. In some embodiments, when a center corresponding block located by the block vector is coded by prediction referencing the current picture, the first prediction candidate is duplicated in the list of prediction candidates, one for block-based IBC mode and another for subblock-based IBC mode.

The multiple vectors of the subblocks may be an affine motion field derived from vectors associated with corners of the current block. The vectors associated with the corners of the current block may be provided by a merge candidate that references the current picture or by searching the current picture. In some embodiments, the current block is coded by IBC-STMVP process, in which subblock of the current block is predicted by a motion that is an average of motions of an above neighbor and of a left neighbor, wherein the motion includes a block vector that references the current picture.

In some embodiments, the video coder implements IBC-subblock-TM merge mode, for which the video coder refines predictions of more than one subblocks of the current block based on template regions neighboring the current block. The predictions are based on vectors referencing the current picture. In some embodiments, the video coder implements IBC with subblock OBMC, in which each subblock of the current block is refined along the subblock's boundary based on blending predictions of the subblock and its neighbor, where a number of lines being blended is determined based a size of the subblock.

In some embodiments, the video coder may receive a skip mode indication for indicating whether a residual for the current block is signaled and used for encoding or decoding the current block based on the selected prediction candidate. If skip mode is used, then no residual will be applied to encode or decode the current block. In some embodiments, the video coder may apply skip mode to prediction modes that reference the current picture (e.g., IntraTMP) to generate one predictor for the entire current block without residual, or multiple predictors for multiple subblocks without residual.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 conceptually illustrates intra block copy (IBC) or current picture referencing (CPR).

FIG. 2 conceptually illustrates search regions for intra template matching.

FIG. 3 shows the use of a block vector of a neighboring block for a current block.

FIG. 4 conceptually illustrates performing template matching based on a search area around an initial motion vector (MV).

FIG. 5 shows spatial and temporal candidates for merge mode.

FIG. 6 shows the control point motion vectors (CPMVs) of a current block that is coded by affine motion field.

FIG. 7 illustrates affine motion field per subblock.

FIG. 8 conceptually illustrates control point motion vector inheritance.

FIG. 9 illustrates a subblock temporal motion vector prediction (SbTMVP) process.

FIG. 10 conceptually recursively deriving motion vectors of sub-CUs by using temporal motion vector predictor and spatial neighboring motion vector.

FIG. 11 conceptually illustrates the locations of blocks that are spatially non-adjacent to a current block 1100.

FIG. 12 conceptually illustrates using the BV of a merge candidate as motion shift for subblocks of a current CU.

FIGS. 13A-D conceptually illustrate template matching being used to refine multiple sub-CUs coded by IBC.

FIG. 14 illustrates an example video encoder that may implement subblock-based IBC or intraTMP modes.

FIG. 15 illustrates portions of the video encoder that implement subblock-based IBC prediction.

FIG. 16 conceptually illustrates a process that uses subblock-based IBC modes to encode a block of pixels.

FIG. 17 illustrates an example video decoder that may implement subblock-based IBC or intraTMP modes.

FIG. 18 illustrates portions of the video decoderthat implement subblock-based IBC prediction.

FIG. 19 conceptually illustrates a process that uses subblock-based IBC modes to decode a block of pixels.

FIG. 20 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

### I. Intra Block Copy (IBC) or Current Picture Referencing (CPR)

Motion Compensation is a video coding process that explores the pixel correlation between adjacent pictures. It is generally assumed that in a video sequence the patterns corresponding to objects or background in a frame are displaced to form corresponding objects on the subsequent frame or correlated with other patterns within the current frame. With the estimation of such a displacement (e.g., using block matching techniques), the pattern could be mostly reproduced without needing to re-code the pattern. Block matching and copy allows selecting the reference block from within the same picture, but it is observed to be not as efficient when applied to camera captured videos. Part of the reasons is that textual pattern in a spatial neighboring area may be similar to the current coding block but usually with some gradual changes over space. It is therefore less likely for a block to find a good match within the same picture of a camera captured video, thereby limiting the improvement in coding performance.

However, the spatial correlation among pixels within the same picture is different for screen content. For a typical video with text and graphics, there are usually repetitive patterns within the same picture. Hence, intra (picture) block compensation has been observed to be very effective. The prediction mode intra block copy (IBC) mode or current picture referencing (CPR) may therefore be used for screen content coding.

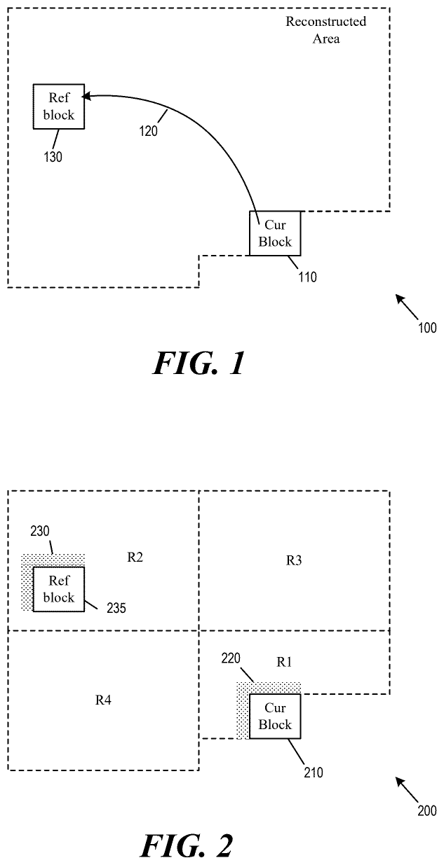

FIG. 1 conceptually illustrates intra block copy (IBC) or current picture referencing (CPR). As illustrated, a prediction unit (PU) as a current block 110 is predicted from a previously reconstructed block 130 within the same picture 100. A displacement vector 120 (called block vector or BV) is used to signal the relative displacement from the position of the current block to that of the reference block, which provides the reference samples used for generating a predictor of the current block. The prediction errors are then coded using transformation, quantization and entropy coding. The reference samples may correspond to the reconstructed samples of the current decoded picture prior to in-loop filter operations, both deblocking and sample adaptive offset (SAO) filters.

### II. Intra Template Matching Prediction (IntraTMP)

Intra template matching prediction (IntraTMP) is a special intra prediction mode that copies the best prediction block from the reconstructed part of the current frame, whose L-shaped template matches a template (current template) neighboring the block being currently coded (current block). For a predefined search range, the encoder searches for the most similar template to the current template in a reconstructed part of the current frame and uses the corresponding block as a prediction block. The encoder then signals the usage of this mode, and the same prediction operation is performed at the decoder side.

FIG. 2 conceptually illustrates search regions for intra template matching. As illustrated, to encode a current block 210 in a current picture 200, the search for a matching L-shape can be conducted in several predefined search regions: R1, which is the current CTU; R2, which is the top-left CTU; R3 which is the above CTU; and R4, which is the left CTU.

Sum of absolute differences (SAD) is used as a cost function, such that within each search region, the decoder searches for the reference template 230 that has the least SAD with respect to a current template 220 neighboring the current block 210. The corresponding block 235 of the reference template 230 is used as a prediction block or reference block. The dimensions of all search regions (SearchRange_w, SearchRange_h) are set proportional to the block dimension (BlkW, BlkH) to have a fixed number of SAD comparisons per pixel. That is: SearchRange_w=a*BlkW, and SearchRange_h=a*BlkH. Where ‘a’ is a constant that controls the gain/complexity trade-off. In some embodiments, ‘a’ is set to 5.

In some embodiments, to speed-up the template matching process, the search range of all search regions is subsampled by a factor of 2. This leads to a reduction of template matching search by 4. After finding the best match, a refinement process is performed. The refinement is done via a second template matching search around the best match with a reduced range. The reduced range is defined as min(BlkW, BlkH)/2.

In some embodiments, intra template matching mode is enabled for CUs with size less than or equal to 64 in width and height. This maximum CU size for Intra template matching is configurable.

In some embodiments, the block vector (BV) derived from the intra template matching prediction (IntraTMP) is used for intra block copy (IBC) prediction mode. In some embodiments, IntraTMP block vectors are added to IBC block vector candidate list as spatial candidates. An IntraTMP block vector may be stored in an IBC block vector buffer and the current IBC block can use both its own IBC BV and the IntraTMP BV of neighboring blocks as BV candidate for IBC BV candidate list. The stored IntraTMP BV of the neighboring blocks along with IBC BV may be used as spatial BV candidates in IBC candidate list construction.

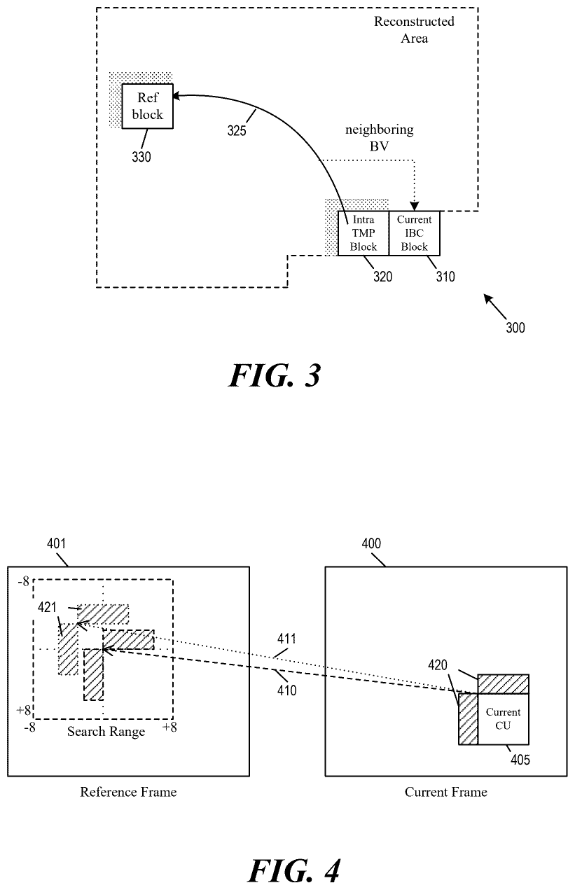

FIG. 3 shows the use of a block vector of a neighboring block for a current block. In the example, a current block 310 in a current picture 300 is coded by IBC, while a neighboring block 320 of the current block is coded by IntraTMP. The IntraTMP coded neighboring block 320 has a BV 325 that is derived by template matching to reference a reference block 330. The BV 325 can be inherited by the current block 310 as a neighboring BV to be part of its IBC candidate list.

III. Refinement based on Template Matching (TM)

Template matching (TM) is a decoder-side MV derivation method to refine the motion information of the current CU by finding the closest match between a template of the current CU (e.g., top and/or left neighbouring blocks of the current CU) in the current picture and a set of pixels (i.e., same size to the template) in a reference picture.

FIG. 4 conceptually illustrates performing template matching based on a search area around an initial motion vector (MV). As illustrated, for a current CU 405 in a current picture 400, the video coder searches the reference picture or frame 401 within a [−8, +8]-pel search range around an initial MV 410 for a better or refined MV 411. The search is based on minimizing the difference (or cost) between a current template 420 neighboring the current block 405 and a reference template 421 identified by the refined MV 411. The template matching may be performed with a search step size that is determined based on an adaptive motion vector resolution mode (AMVR). The template matching process can be cascaded with a bilateral matching process in merge modes.

In advanced motion vector prediction (AMVP) mode, an MVP candidate is determined based on template matching error to select the one that reaches the minimum difference between the current block template and the reference block template, and then TM is performed only for this particular MVP candidate for MV refinement. The TM process refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on a AMVR mode search pattern according to Table 1 below.

TABLE 1
Search patterns of AMVR and merge mode with AMVR

| | AMVR mode | | | | | |
|---|---|---|---|---|---|---|
| | 4- | Full- | Half- | Quarter- | Merge mode | |
| Search pattern | pel | pel | pel | pel | AltIF = 0 | AltIF = 1 |
| 4-pel diamond | v | | | | | |
| 4-pel cross | v | | | | | |
| Full-pel diamond | | v | v | v | v | v |
| Full-pel cross | | v | v | v | v | v |
| Half-pel cross | | | v | v | v | v |
| Quarter-pel cross | | | | v | v | |
| ⅛-pel cross | | | | | v | |

This search process ensures that the MVP candidate still keeps the same MV precision as indicated by the AMVR mode after the TM process. In the search process, if the difference between the previous minimum cost and the current minimum cost in the iteration is less than a threshold that is equal to the area of the block, the search process terminates.

In some embodiments, when using merge mode, the video coder may apply a similar TM search method to refine the merge candidate indicated by the merge index. As Table 1 above shows, TM may be performed all the way down to ⅛-pel MVD precision or skipping those beyond half-pel MVD precision, depending on whether an alternative interpolation filter (that is used when AMVR is of half-pel mode) is used according to merged motion information.

### IV. Merge Mode

Skip and Merge modes obtain the motion information from spatially neighboring blocks (spatial candidates) or a temporal co-located block (temporal candidate). When a PU is Skip or Merge mode, no motion information is coded, instead, only the index of the selected candidate is coded. For Skip mode, the residual signal is forced to be zero and not coded. If a particular block is encoded as Skip or Merge, a candidate index is signaled to indicate which candidate among the candidate set is used for merging. Each merged PU reuses the MV, prediction direction, and reference picture index of the selected candidate.

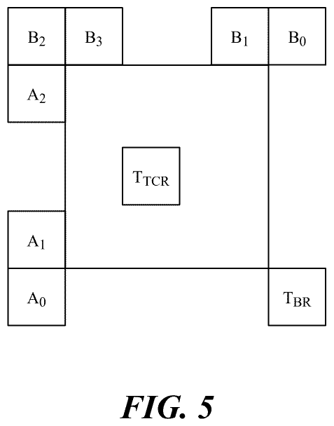

FIG. 5 shows spatial and temporal candidates for merge mode. As illustrated, up to four spatial MV candidates are derived from A₀, A₁, B₀ and B₁ spatial neighbors, and one temporal MV candidate is derived from TBR or TCTR (TBR is used first, if TBR is not available, TCTR is used instead). If any of the four spatial MV candidates is not available, the position B₂ is then used to derive MV candidate as a replacement. After the derivation process of the four spatial MV candidates and one temporal MV candidate, removing redundancy (pruning) is applied to remove redundant MV candidates. If after removing redundancy (pruning), the number of available MV candidates is smaller than five, three types of additional candidates are derived and are added to the candidate set (candidate list). The encoder selects one final candidate within the candidate set for Skip, or Merge modes based on the rate-distortion optimization (RDO) decision, and transmits the index to the decoder.

### V Affine Prediction

a. Affine Motion Field

An object in a video may have different types of motion, including translation motions, zoom in/out motions, rotation motions, perspective motions and the other irregular motions. In some embodiments, a block-based affine transform motion compensation prediction is used to account for these various types of motion. A block-based affine transform motion compensation prediction may be used. Specifically, the affine motion field mvₓ, mv_{y} of the current block at position (x, y) is in the form of a linear model:

$$m {v}_{x} = a * x + b * y + c \qquad ( 0 )$$

$$m {v}_{y} = d * x + e * y + f$$

The coefficients {a, b, c, d, e, f} are parameters of the linear model. In some embodiments, the affine motion field at position (x, y) can be described by motion information of two control points (CPs) (at e.g., top-right and top-left corners of the block) (4-parameter model) or motion information of three control points (at e.g., top-right, top-left, and bottom-left corners of the block) (6-parameter model).

For 4-parameter affine motion model, eq.0 (motion vector at sample location (x, y) in a block) can be written as:

$$\{ \begin{matrix}m {v}_{x} = \frac{m {v}_{1 x} - m {v}_{0 x}}{W} x + \frac{m {v}_{0 y} - m {v}_{1 y}}{W} y + m {v}_{0 x} \\ m {v}_{y} = \frac{m {v}_{1 y} - m {v}_{0 y}}{W} x + \frac{m {v}_{1 x} - m {v}_{0 x}}{W} y + m {v}_{0 y}\end{matrix} \qquad ( 1 )$$

For 6-parameter affine motion model, eq.0 can be written as:

$$\{ \begin{matrix}m {v}_{x} = \frac{m {v}_{1 x} - {mv}_{0 x}}{W} x + \frac{m {v}_{2 x} - m {v}_{0 x}}{H} y + m {v}_{0 x} \\ m {v}_{y} = \frac{m {v}_{1 y} - m {v}_{0 y}}{W} x + \frac{m {v}_{2 y} - m {v}_{0 y}}{H} y + m {v}_{0 y}\end{matrix} \qquad ( 2 )$$

Where (mv₀ₓ, mv_{0y}) is motion vector of the top-left corner control point (top-left corner CPMV, or mv₀), (mv₁ₓ, mv_{1y}) is the motion vector of the top-right corner control point (top-right corner CPMV, or mv₁), and (mv_{2X}, mv_{2y}) is the motion vector of the bottom-left corner control point (bottom-left corner CPMV, or mv₂).

In some embodiments, a 2-parameter model can be used to refine translation inter-prediction candidate (e.g., regular merge candidates):

$$M {V}_{x}^{r e g r e s s} = M {V}_{x}^{orig} + biasX \qquad ( 3 )$$

$${MV}_{y}^{r e g r e s s} = {MV}_{y}^{orig} + biasY$$

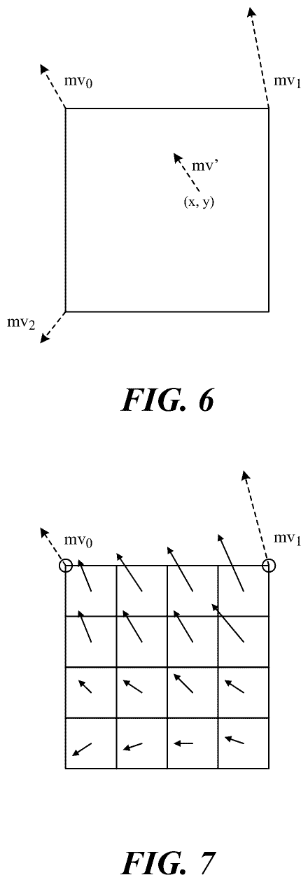

FIG. 6 shows the control point motion vectors (CPMVs) of a current block that is coded by affine motion field. The current block has CPMVs at top-left corner (mv₀), top-right-corner (mv₁), and bottom-left corner (mv₂). The affine motion field mv′ at positions (x, y) in the current block 200 can be derived using an affine motion model such as eq.1 (4-parameter affine model) or eq.2 (6-parameter affine model).

In order to simplify the motion compensation prediction, block based affine transform prediction is applied. FIG. 7 illustrates affine motion field per subblock. The figure illustrates a motion field of motion vectors for a block having 16 4×4 subblocks. To derive the motion vector of each 4×4 luma subblock, the motion vector of the center sample of each subblock. is calculated according to eq. 1 or eq. 2, and rounded to 1/16 fraction accuracy. A motion compensation interpolation filters can be applied to generate the prediction of each subblock with derived motion vector. The subblock size of chroma-components is also set to be 4×4. The MV of a 4×4 chroma subblock is calculated as the average of the MVs of the top-left and bottom-right luma subblocks in the collocated 8×8 luma region.

b. Affine Merge Mode

In affine merge mode, the motion vectors at the control points (CPMVs) of the current CU are generated based on the motion information of the spatial neighboring CUs. There can be up to five CPMVP candidates, and an index is signalled to indicate the one to be used for the current CU. The following three types of CPMV candidates are used to form the affine merge candidate list: (1) inherited affine merge candidates that are extrapolated from the CPMVs of the neighbour CUs; (2) constructed affine merge candidates CPMVPs that are derived using the translational MVs of the neighbour CUs; (3) zero MVs.

An inherited affine candidate inherits an affine model from a neighboring block by directly obtaining the CPMVs from the neighboring blocks (one from left neighboring CUs and one from above neighboring CUs). The candidate neighboring blocks for inheriting affine candidates are as shown in FIG. 5 above. For the left predictor, the scan order of the candidate blocks is A₁→A₀, and for the above predictor, the scan order for the candidate blocks is B₁→B₀→B₂. When a neighboring affine CU is identified, its control point motion vectors are used to derive the CPMVP candidate in the affine merge list of the current CU.

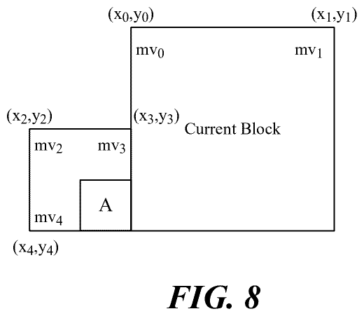

FIG. 8 conceptually illustrates control point motion vector inheritance. As illustrated, for a current block 810, if a left-bottom neighboring block A is coded in affine mode, the motion vectors mv2, mv3, and mv4 of the top left corner, above right corner and left bottom corner of a CU 820 that contains the block A can be inherited by the current block 810. When block A is coded with 4-parameter affine model, the two CPMVs of the current CU 810 can be calculated according to mv₂ and mv₃. In case that block A is coded with 6-parameter affine model, the three CPMVs of the current CU 810 may be calculated according to mv₂, mv₃, and mv₄.

Constructed affine candidate means the candidate is constructed by combining the neighbor translational motion information of each control point. The motion information for the control points is derived from the specified spatial neighbors and temporal neighbor shown in FIG. 5. CPMVₖ (k=1, 2, 3, 4) represents the k-th control point. For CPMV₁, the B₂→B₃→A₂ blocks are checked and the MV of the first available block is used. For CPMV₂, the B₁→B₀ blocks are checked and for CPMV₃, the A₁→A₀ blocks are checked. For TMVP is used as CPMV₄ if it's available. After MVs of four control points are attained, affine merge candidates are constructed based on those motion information. The following combinations of control point MVs are used to construct in order: {CPMV₁, CPMV₂, CPMV₃}, {CPMV₁, CPMV₂, CPMV₄}, {CPMV₁, CPMV₃, CPMV₄}, {CPMV₂, CPMV₃, CPMV₄}, {CPMV₁, CPMV₂}, {CPMV₁, CPMV₃}. The combination of 3 CPMVs constructs a 6-parameter affine merge candidate and the combination of 2 CPMVs constructs a 4-parameter affine merge candidate. To avoid motion scaling process, if the reference indices of control points are different, the related combination of control point MVs is discarded. After inherited affine merge candidates and constructed affine merge candidate are checked, if the list is still not full, zero MVs are inserted to the end of the list.

c. Affine AMVP Prediction

Affine AMVP mode can be applied to CUs with both width and height larger than or equal to 16. An affine flag in CU level is signalled in the bitstream to indicate whether affine AMVP mode is used and then another flag is signalled to indicate whether 4-parameter affine or 6-parameter affine. In this mode, the difference of the CPMVs of current CU and their predictors CPMVPs is signalled in the bitstream. The affine AVMP candidate list size is 2 and it is generated by using the following four types of CPMV candidate in order: (1) Inherited affine AMVP candidates that extrapolated from the CPMVs of the neighbour CUs, (2) Constructed affine AMVP candidates CPMVPs that are derived using the translational MVs of the neighbour CUs, (3) Translational MVs from neighboring CUs, and (4) Zero MVs.

The checking order of inherited affine AMVP candidates is same to the checking order of inherited affine merge candidates. The only difference is that, for AVMP candidate, only the affine CU that has the same reference picture as in current block is considered. No pruning process is applied when inserting an inherited affine motion predictor into the candidate list.

Constructed AMVP candidate is derived from the specified spatial neighbors shown in FIG. 5 above. The same checking order is used as in affine merge candidate construction. In addition, reference picture index of the neighboring block is also checked. The first block in the checking order is inter coded and uses the same reference picture as in current CUs. When the current CU is coded with 4-parameter affine mode, and mv₀ and mv₁ are both available, they are added as one candidate in the affine AMVP list. When the current CU is coded with 6-parameter affine mode, and all three CPMVs are available, they are added as one candidate in the affine AMVP list. Otherwise, constructed AMVP candidate is set as unavailable.

If the affine AMVP candidates list still has less than 2 candidates after valid inherited affine AMVP candidates and constructed AMVP candidate are inserted, mv₀, mv₁, and mv₂ will be added, in order, as the translational MVs to predict all control point MVs of the current CU, when available. Finally, zero MVs are used to fill the affine AMVP candidates list if the list is still not full.

### VI. Reconstruction-Reordered IBC

A Reconstruction-Reordered IBC (RR-IBC) mode is allowed for IBC coded blocks. When RR-IBC is applied, the samples in a reconstruction block are flipped according to a flip type of the current block. At the encoder side, the original block is flipped before motion search and residual calculation, while the prediction block is derived without flipping. At the decoder side, the reconstruction block is flipped back to restore the original block.

Two flip methods, horizontal flip and vertical flip, are supported for RR-IBC coded blocks. A syntax flag is firstly signalled for an IBC AMVP coded block, indicating whether the reconstruction is flipped, and if it is flipped, another flag is further signaled specifying the flip type. For IBC merge, the flip type is inherited from neighbouring blocks, without syntax signalling. Considering the horizontal or vertical symmetry, the current block and the reference block are normally aligned horizontally or vertically. Therefore, when a horizontal flip is applied, the vertical component of the BV is not signaled and inferred to be equal to 0. Similarly, the horizontal component of the BV is not signaled and inferred to be equal to 0 when a vertical flip is applied.

### VII. Subblock-Based Temporal Motion Vector Prediction (SbTMVP)

Subblock-based temporal motion vector prediction (SbTMVP) uses the motion field in the collocated picture to improve motion vector prediction and merge mode for CUs in the current picture. The same collocated picture used by temporal motion vector prediction (TMVP) is used for SbTMVP. SbTMVP differs from TMVP in that (1) TMVP predicts motion at CU level but SbTMVP predicts motion at sub-CU level, and (2) whereas TMVP fetches the temporal motion vectors from the collocated block in the collocated picture (the collocated block is the bottom-right or center block relative to the current CU), SbTMVP applies a motion shift before fetching the temporal motion information from the collocated picture, where the motion shift is obtained from the motion vector from one of the spatial neighboring blocks of the current CU.

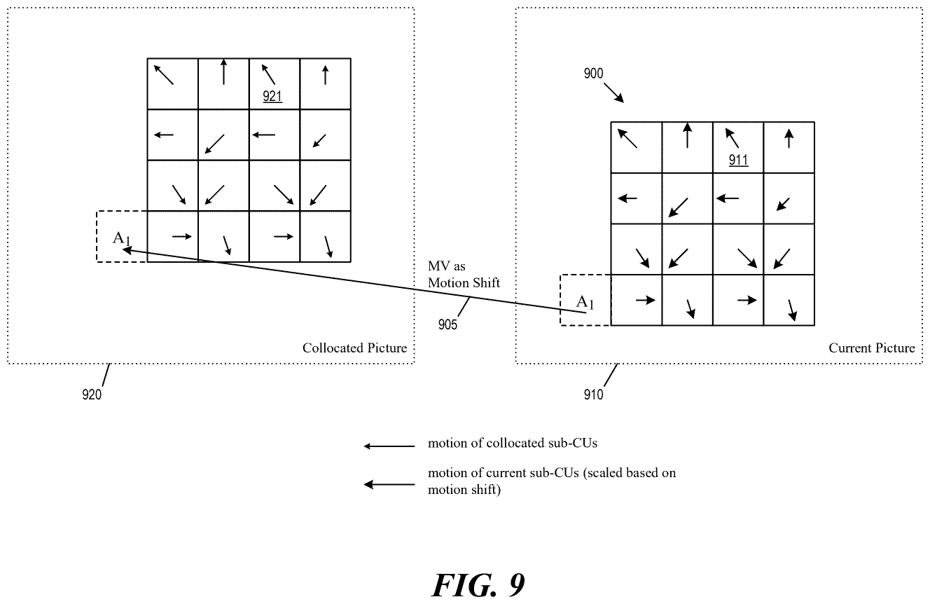

FIG. 9 illustrates a subblock temporal motion vector prediction (SbTMVP) process. The figure illustrates deriving sub-CU motion field by applying a motion shift from spatial neighbor and scaling the motion information from the corresponding collocated sub-CUs. SbTMVP predicts the motion vectors of the sub-CUs within a current CU 900 in a current picture 910 in two steps. In the first step (Step 1), the spatial neighbors A₁ of the current CU is examined, such that if A₁ has a motion vector 905 that uses the collocated picture 920 as its reference picture, this motion vector 905 is selected to be the motion shift to be applied in the SbTMVP process. If no such motion is identified, then the motion shift is set to (0, 0).

In the second step, the motion shift is applied (i.e., added to the current block's coordinates) to obtain sub-CU level motion information (motion vectors and reference indices) from the collocated picture as shown in FIG. 9. In the example of FIG. 9, the motion shift is set to block A₁'s motion. Then, for each sub-CU of the current block 900, the motion information of the sub-CU's corresponding block (the smallest motion grid that covers the center sample) in the collocated picture is used to derive the motion information for the sub-CU. (For example, the motion information of a collocated sub-CU 921 in the collocated picture is scaled to serve as the motion information of a sub-CU 911 in the current block 900 of the current picture.)

After the motion information of the collocated sub-CU is identified, it is converted to the motion vectors and reference indices of the current sub-CU in a similar way as the TMVP process of HEVC, where temporal motion scaling is applied to align the reference pictures of the temporal motion vectors to those of the current CU by e.g., scaling based on temporal distances between the current picture, the collocated picture, and the reference picture(s) of the motion information of the collocated sub-CU.

A combined subblock based merge list which contains both SbTMVP candidate and affine merge candidates may be used for the signalling of subblock based merge mode. The SbTMVP mode is enabled/disabled by a sequence parameter set (SPS) flag. If the SbTMVP mode is enabled, the SbTMVP predictor is added as the first entry of the list of subblock-based merge candidates, and followed by the affine merge candidates. The size of subblock based merge list is signalled in SPS and the maximum allowed size of the subblock based merge list may be 5. The sub-CU size used in SbTMVP is fixed to be 8×8, and as done for affine merge mode, SbTMVP mode is only applicable to the CU with both width and height are larger than or equal to 8. The encoding logic of the additional SbTMVP merge candidate is the same as for the other merge candidates, that is, for each CU in P or B slice, an additional RD check is performed to decide whether to use the SbTMVP candidate.

### VIII. Spatial-Temporal Motion Vector Prediction (STMVP)

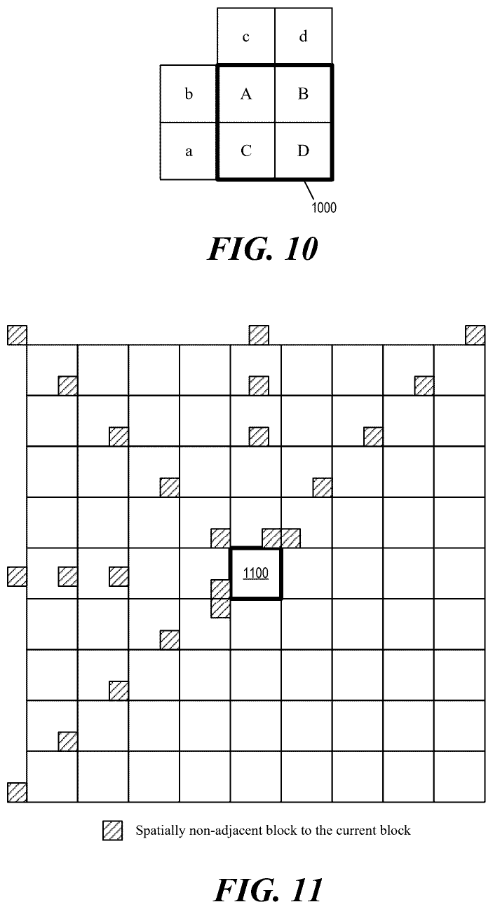

In some embodiments, a spatial-temporal motion vector prediction (STMVP) is included in merge mode coding. In STMVP, the motion vectors of the sub-CUs are derived recursively following raster scan order by using the temporal motion vector predictor and spatial neighbouring motion vector. FIG. 10 conceptually recursively deriving motion vectors of sub-CUs by using temporal motion vector predictor and spatial neighboring motion vector. The figure shows an 8×8 CU 1000 which contains four 4×4 sub-CUs, A, B, C, and D. The neighbouring N×N blocks in the current frame are labeled as a, b, c, and d. The motion derivation for sub-CU A starts by identifying its two spatial neighbours. The first neighbour is N×N block above sub-CU A (block c). If this block c is not available or is intra coded the other N×N blocks above sub-CU A are checked (from left to right, starting at block c). The second neighbour is a block to the left of the sub-CU A (block b). If block b is not available or is intra coded other blocks to the left of sub-CU A are checked (from top to bottom, staring at block b). The motion information obtained from the neighbouring blocks for each list is scaled to the first reference frame for a given list. Next, temporal motion vector predictor (TMVP) of sub-block A is derived by following the same procedure of TMVP derivation as specified in HEVC. The motion information of the co-located block at location D is fetched and scaled accordingly. At last, after retrieving and scaling the motion information, all available motion vectors (up to 3) are averaged separately for each reference list. The averaged motion vector is assigned as the motion vector of the current sub-CU. IX. Coding tools in Combinations with IBC or IntraTMP

Some embodiments provide skip mode and affine mode methods in Intra Block Copy (IBC) mode and Intra-Template-Matching (IntraTMP) mode.

a. IBC with Skip Mode

In some embodiments, when the current block is coded with IBC mode or IntraTMP mode, skip mode can be applied to current block. IBC skip mode and IntraTMP skip mode may consider (but not limited to) different template-types, different search ranges or reconstruction-reordered types, or a combination thereof.

In some embodiments, when the current block is coded with IntraTMP mode, skip mode can be applied to current block. A CU skip flag is signaled and there is no residual signaled. In some embodiments, when reconstruction-reordered IntraTMP mode is applied, skip mode can be applied to the current block. A CU skip flag is signaled and there is no residual signaled. In some embodiments, when reconstruction-reordered IBC mode is applied, skip mode can be applied to current block. A CU skip flag is signaled and there is no residual signaled.

In some embodiments, when the current block is coded with IntraTMP skip mode, the search range of IntraTMP is decreased. In some embodiments, when the current block is coded with IntraTMP skip mode, the search range of IntraTMP is increased. In some embodiment, when current block luma component is coded with IntraTMP skip mode, current block chroma block directly inherit the IntraTMP skip mode from luma component. In some embodiment, when performing motion search in IBC mode or IntraTMP mode, current blocks coded with IntraTMP mode can use the BV in IBC mode as current block's motion shift or current blocks coded with IBC mode can use the motion shift in IntraTMP mode as current block's BV.

In some embodiments, when performing motion search in IBC mode or IntraTMP mode, a current block coded with IntraTMP skip mode may use the BV in IBC mode as the current block's motion shift. In some embodiments, a current block coded with IBC skip mode can use the motion shift in IntraTMP mode as the current block's BV. In some embodiments, when a current block's neighboring blocks are coded with IBC skip mode or IntraTMP skip mode, the current block is inferred to be coded by IBC skip mode or IntraTMP skip mode.

b. IBC with Affine AMVP or Affine Merge Mode

In some embodiments, when a current block is coded with IBC mode or IntraTMP mode, affine AMVP mode or affine merge mode can be applied to the current block. Specifically, the CPMVs of the current block are BVs (from IBC/IntraTMP merge or IBC/IntraTMP AMVP) that reference positions within the current picture, and the derived affine motion field are BVs of the subblocks.

IntraTMP affine AMVP mode or IntraTMP affine merge mode may consider but not limited to, different template-types or different reconstruction-reordered types or a combination thereof. IBC affine AMVP mode or IBC affine merge mode may consider but not limited to different search ranges, different reconstruction-reordered types, or a combination thereof.

In some embodiments, when the current block is coded with IntraTMP mode with top template available, the two CPMVs at the current block's left-top and right-top corners are considered using the top template. In some embodiments, when the current block is coded with IntraTMP mode with left template available, the two CPMVs at the current block's left-top and left-bottom corners are considered using the left template. In some embodiment, when the current block is coded using IntaTMP mode with top template available and left template available, the two or three CPMVs are considered using both template regions.

In some embodiments, when current block is coded with IBC mode or IntaTMP mode, affine merge mode or affine AMVP mode is applied to current block and reconstruction-reordered may also be applied to current block. In some embodiments, when the current block is coded with IBC mode or IntaTMP mode, affine merge mode or affine AMVP mode may be applied to the current block, and reconstruction-reordered is disabled. In some embodiments, when the current block is coded with IntraTMP mode and affine mode is applied to the current block, when deriving the motion shift, template-matching with least-square method may be used.

c. Inherited Affine Model

In some embodiments, for a current block coded using IBC affine AMVP mode or IBC affine merge mode or IntraTMP affine AMVP mode or IntraTMP affine merge mode, when deriving the affine model for the current block, the current block may inherit affine models from spatially neighboring affine blocks. The locations of the blocks that spatially neighboring the current block, such as positions A₀, A₁, B₀, B₁, B₂ for the current block, are illustrated in FIG. 5 above.

In some embodiments, for a current block coded using IBC affine AMVP mode or IBC affine merge mode or IntraTMP affine AMVP mode or IntraTMP affine merge mode, when deriving affine model for the current block, the current block may inherit affine models from non-adjacent spatial affine blocks. FIG. 11 conceptually illustrates the locations of blocks that are spatially non-adjacent to a current block 1100.

In some embodiments, for IBC affine AMVP mode or IBC affine merge mode or IntraTMP affine AMVP mode or IntraTMP affine merge mode, when deriving affine model for the current block, the current block may inherit affine models from history-based affine candidates or regression-based affine candidates.

d. Constructed Affine Model

In some embodiments, for a current block coded using IBC affine AMVP mode or IBC affine merge mode or IntraTMP affine AMVP mode or IntraTMP affine merge mode, when deriving affine model for a current block, CPMVs for the current block may be derived to construct affine model from spatial neighboring affine blocks such as B₂, B₃, B₁, B₀, A₁, A₀ as shown in FIG. 5. In some embodiments, for a current block coded using IBC affine AMVP mode or IBC affine merge mode or IntraTMP affine AMVP mode or IntraTMP affine merge mode, when deriving affine model for the current block, CPMVs for the current block may be derived to construct affine model from non-adjacent spatial affine blocks, as shown in FIG. 11.

In some embodiments, for a current block coded using IBC affine AMVP mode or IBC affine merge mode or IntraTMP affine AMVP mode or IntraTMP affine merge mode, when deriving an affine model for the current block, CPMVs of the current block may be derived to construct affine model from history-based affine blocks.

e. Block Vector Constraint

In some embodiments, for a current block coded with IBC affine mode or IntraTMP affine mode, every CPMV of the current block is confined to an IBC BV constraint. In some embodiments, for a current block coded with IBC affine mode or IntraTMP affine mode, every subblock MV of the current block is confined to an IBC BV constraint.

f. History-based Candidate List

In some embodiments, when encoding or decoding blocks coded with IBC affine AMVP mode or IBC affine merge mode or IntraTMP affine AMVP mode or IntraTMP affine merge mode, a joint or a unified history-based affine candidate list is used for IBC affine mode and IntraTMP affine mode. In some embodiments, two separate history-based affine candidate lists are used, one list for IBC affine (AMVP or merge) modes and the other list for IntraTMP affine (AMVP or merge) modes.

In some embodiments, for IBC affine AMVP mode or IBC affine merge mode or IntraTMP affine AMVP mode or IntraTMP affine merge mode, history-based affine candidate list is updated when encoding or decoding each block coded in IBC affine mode or IntraTMP affine mode. In some embodiments, history-based affine candidate list is updated when encoding or decoding the first N blocks or the last N blocks coded in IBC affine mode or IntraTMP affine mode, where N is larger than or equal to 0. In some embodiments, a merging estimation region is utilized and history-based affine candidate list is updated when encoding or decoding the first N blocks or the last N blocks coded in IBC affine mode or IntraTMP affine mode in merging estimation region, where N is larger than or equal to 0. In some embodiments, history-based affine candidate list is updated per CTU or per CTU row or per picture.

g. Template Matching Refinement

In some embodiments, two or three Affine CPMVs can be further refined by template matching respectively. The refined CPMVs are then used to derive a new Affine model for an IBC/IntraTMP Affine CU.

In some embodiments, the BVs of each IBC/IntraTMP subblock are refined by template matching. A regression process which minimizes the mean-square error between refined subblock BVs and regression BVs is then performed to derive a new Affine model for the IBC/IntraTMP Affine CU.

X. Subblock Modes with IBC or IntraTMP
h. Mixed sbTMVP Mode

In some embodiments, in sbTMVP (subblock TMVP) mode, for each sub-CU, both the MV and/or BV of its corresponding block (the smallest motion grid that covers the center sample) in the collocated picture are used to derive the motion information for the sub-CU. If the corresponding block in the collocated picture is coded by non-IBC inter mode, the block includes MV information. If the corresponding block in the collocated picture is coded by IBC mode, the block includes BV information.

In some embodiments, if the referenced block in collocated picture is coded by IBC, its BV can be directly referenced by the sub-CU without scaling. In some embodiment, if an IBC coded block is referenced by sbTMVP, its BV can be directly referenced without scaling. And a validation check shall be performed to make sure that this BV can be referenced by current CU or current sub-CUs.

In some embodiments, if the referenced block is coded by IBC, and its BV cannot be referenced by current CU or sub-CUs (i.e., the to-be referenced block is overlapped with current block; the to-be referenced block includes some not-decoded samples), a default BV will be used. For example, if the referenced BV is out of IBC's valid referenced region or the referenced block is overlapped with current CU or sub-CUs, the BV cannot be referenced. In this case, a pre-defined default BV can be used.

For sbTMVP, the spatial neighbor A1 in FIG. 9 has a MV 905 that uses the collocated picture 920 as its reference picture, this MV is selected to be the motion shift to be applied. The spatial neighbor A1 can be any other merge candidate, e.g., a spatial merge candidate, a historical candidate, a pairwise candidate, or a NAMVP candidate, and so on. In some embodiments, if the referenced block has a BV, the BV will be directly used to derive the motion shift without scaling. After the derived motion shift is applied, for each sub-CU, the motion information of its corresponding block in the collocated picture is used to derive the motion information for the sub-CU and the corresponding block must be an IBC or intraTMP coded block. If one corresponding block is not an IBC or intraTMP coded block, a default BV will be used. On the other side, if the referenced block has a MV, the MV will be used to derive the motion shift with scaling. After the derived motion shift is applied, for each sub-CU, the motion information of its corresponding block in the collocated picture is used to derive the motion information for the sub-CU and the corresponding block must be a non-IBC coded block. If one corresponding block is an IBC or intraTMP coded block, a default BV will be used.

The above-mentioned default BV/MV can be the BV/MV of any position inside a CU, for example, the top-left, the center position, the bottom-left position of the CU. The above-mentioned default BV/MV can be the motion used to derive motion shift of sbTMVP. The above-mentioned default BV/MV can be the previous coded CU's motion. In that, if the previously coded CU's motion is a BV, it can be directly used. If the previously coded CU's motion is a MV, it can be used after scaling.

j. IBC-sbTMVP Mode

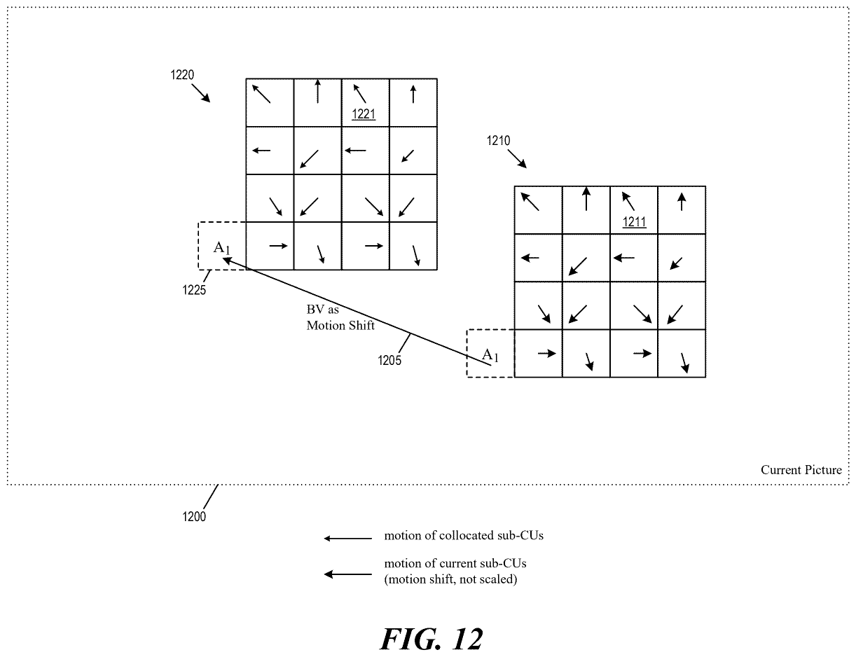

Some embodiments of the disclosure provide a merge mode that may include one or more subblock merge candidates and/or one or more IBC candidates. In some embodiments, such a merge mode may include subblock merge candidates in which the BV of a merge candidate is applied as motion shift to a motion field of subblocks of the current CU. Such a mode may be referred to as IBC-sbTMVP mode. FIG. 12 conceptually illustrates using the BV of a merge candidate as motion shift for subblocks of a current CU.

The figure illustrates a current CU 1210 having a merge candidate 1215 (A1). The merge candidate 1215 is a spatial neighbor having a BV 1205 that references another block 1225 in the current picture 1200. The merge candidate 1215 maybe a subblock based merge candidate, such that the referenced block 1225 of the merge candidate 1215 is a spatial neighbor of a reference region 1220 that is coded by a motion field of subblocks.

The BV 1205 is used to derive the motion shift for the current CU 1210 without scaling, since there is no temporal difference. After the derivation of the motion shift, for each sub-CU of the current CU 1210, the motion information of each sub-CU's corresponding block in the current picture 1200 is used to derive the motion information for the sub-CU. For example, a subblock 1211 in the current CU has a corresponding block 1221 in the reference region 1220 from which its motion information is derived.

In some embodiments, the corresponding block from which the motion information is derived is required to be an IBC or intraTMP coded block. IBC subblock candidates are included in the IBC merge list. For some embodiments, subblock candidates cannot apply to RRIBC, IBC-LIC, IBC-GPM and IBC-CIIP.

In some embodiments, in IBC merge candidate list, for each inserted candidate, if the candidate can derive a motion shift and the motion shift can find a valid corresponding center block which is coded by IBC or intraTMP, the candidate will be duplicated in the IBC merge candidate list. In that, the first candidate is for block-based IBC mode and the second candidate is for subblock-based IBC mode.

In some embodiments, a list is specialized for IBC subblock mode. Only if the merge candidate can derive a motion shift and the motion shift can find a valid corresponding center block which is coded by IBC or intraTMP, can the merge candidate be inserted into IBC subblock merge candidate list.

In some embodiments, a syntax is signaled to indicate whether IBC subblock mode is applied, i.e., ibc_sublk_flag. In some embodiments, not only ibc_sublk_flag is signaled, ibc_sublk_merge_idx is further signaled when ibc_sublk_flag is true. Ibc_sublk_merge_idx is used to indicate which IBC subblock mode candidate is performed. In some other embodiments, no additional IBC subblock related syntax is signaled. IBC-subblock merge candidates are treated as IBC merge candidates. IBC-subblock merge candidates can be indicated by merge_idx. Moreover, with this design, if there is no valid IBC subblock candidate, no redundant syntax will be introduced.

k. IBC-STMVP Mode

The derivation of above-mentioned IBC subblock mode can be changed to IBC-STMVP mode. The above-mentioned IBC subblock mode syntax design can also be performed with IBC-STMVP.

In some embodiments, for IBC-STMVP mode, the sub-CU motions are derived by averaging neighboring block's motion information. FIG. 10 above shows an example coding unit with four sub-blocks (A, B, C, D) and neighboring blocks (a, b, c, d).

For example, motion in sub-CU “A” can be the averaging of motion in block c and motion in block b. Motion in sub-CU “B” can be the averaging of motion in block d and motion in block A. Motion in sub-CU “C” can be the averaging of motion in block A and motion in block a. Motion in sub-CU “D” can be the averaging of motion in block B and motion in block C.

For another example, motion in sub-CU “A” can be the weighted averaging of motion in block c and motion in block b. Motion in sub-CU “B” can be the weighted averaging of motion in block d and motion in block b. Motion in sub-CU “C” can be the weighted averaging of motion in block c and motion in block a. Motion in sub-CU “D” can be the weighted averaging of motion in block d and motion in block a. The weighting of motion information of the referenced block far away from current block will be smaller than the weighting of motion information of the referenced block closer to current block. For example, the derivation formula of the final motion of sub-CU “B” may be calculated as (3*motion in block c+1*motion in block b).

In some embodiments, if the nearest neighboring block is not IBC coded, other adjacent blocks may be referenced. For example, during the derivation of sub-CU “A”, block c and block b's motions will be referenced. If block c is coded by intra, block d's motion will be used. In some embodiment, if the to-be referenced block pointed by the averaging motion of one sub-CU is overlapped with current sub-CU, a copy-padding method can be applied. In that, the overlapped samples can be filled by the available samples.

In some embodiments, a final sub-CU predictor is generated by blending neighboring referencing predictors. For example, the motion in sub-CU “c” is used to generate a first predictor. Motion in sub-CU “b” is used to generate a second predictor. The final predictor of sub-CU “A” is generated by blending the first predictor and the second predictor. For another example, motion in sub-CU “d” is used to generate a first predictor. Motion in sub-CU “b” is used to generate a second predictor. The final predictor of sub-CU “B” is generated by blending the first predictor and the second predictor. The blending weights of neighboring referencing predictors can be designed based on the distance between the referencing blocks and current block. For example, blending weight for the first predictor generated according to motion in sub-CU “d” is larger than blending weight for the second predictor generated according to motion in sub-CU “b”.

XI. IBC with Template Matching Based Subblock Modes
L. IBC with Subblock-Based Prediction Modes

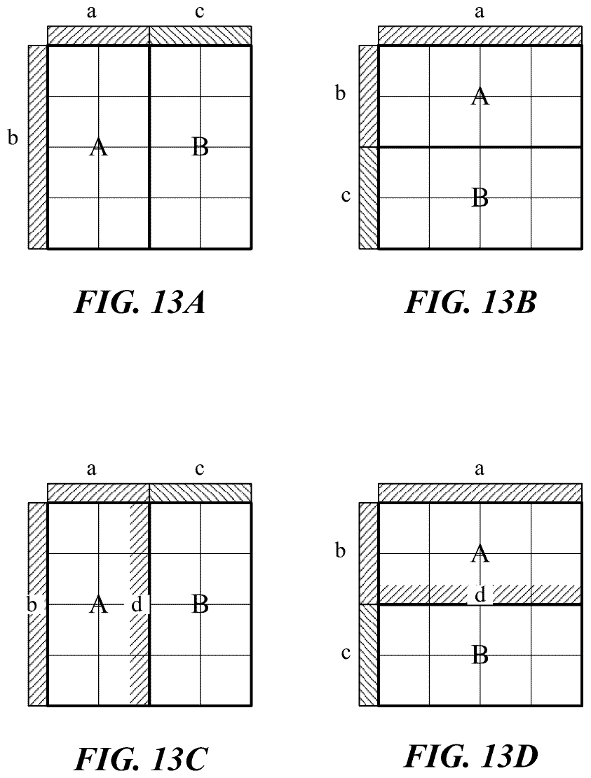

In some embodiments, template matching (TM) can be used to refine multiple sub-CUs coded by IBC. Using template matching to refine a prediction is described by reference to FIG. 4 above. FIGS. 13A-D conceptually illustrate template matching being used to refine multiple sub-CUs coded by IBC. The figures illustrate a CU that is partitioned into two sub-CUs, sub-CU A and sub-CU B. The motion information (MV or BV) of each sub-CU is refined by template matching based on the sub-CU's associated templates (e.g., templates a and b for sub-CU A) when used to generate the prediction.

FIGS. 13A-B shows examples in which sub-CU A is refined by templates a and b, and that sub-CU B is refined by template c. FIGS. 13C-D shows examples in which sub-CU A is refined by templates a and b, and sub-CU B is refined by templates c and d. The template d is part of predictor of sub-CU A. In some embodiments, the template d can be the reconstruction of sub-CU A. In some embodiments, if the refined motion (MV or BV) is invalid for the current sub-CU (the to-be referenced block is overlapped with current sub-CU), the original motion is used (MV or BV inherited from merge candidates).

In some embodiments, template matching can be used to refine the motion (MV or BV) of multiple sub-CUs coded by IBC. For example, in FIG. 13A, template a is used to refine sub-CU “A”. The corresponding templates of candidates in IBC merge candidate list will be generated and compared with template a, and the one with smallest SAD/SATD cost will be selected to generate the first predictor. In the next step, template b is used to refine sub-CU “A”. The corresponding templates of candidates in IBC merge candidate list will be generated and compared with template b, and the one with smallest SAD/SATD cost will be selected to generate the second predictor. After that, the final predictor for sub-CU “A” is generated by averaging the first predictor and the second predictor. For sub-CU “B”, template c and template b are used to recommend two predictors, and after that, the final predictor is generated by blending two predictors.

In some embodiments, a position-based weighting can be applied. For example, samples closed to the top boundary will apply to larger weightings on the first predictor that is derived by the top template. Samples closed to the left boundary will apply larger weightings on the second predictor that is derived by the left template.

In some embodiments, a syntax (e.g., ibc_sublk_flag) is signaled to indicate whether IBC subblock mode is applied. In another embodiment, not only ibc_sublk_flag is signaled, ibc_sublk_merge_idx is further signaled when ibc_sublk_flag is true. Ibc_sublk_merge_idx is used to indicate which IBC subblock mode candidate is performed. In some other embodiments, no additional ibc subblock related syntax is signaled. IBC-subblock merge candidates are treated as IBC merge candidates. IBC-subblock merge candidates can be indicated by merge_idx. Moreover, with this design, if the is no valid IBC subblock candidate, no redundant syntax will be introduced. For example, the ibc subblock mode is indicated by merge_idx equal to 0.

m. IBC-TM-Based Multi-Predictor Mode

In some embodiments, template matching can be used to derive the predictor for IBC coded block. First, the top template of the current block is used to represent (or as the current template of) the current CU. The corresponding templates of candidates in IBC merge candidate list will be generated and compared with the current top template, and the one with smallest SAD/SATD cost will be selected to generate the first predictor. In the next step, the left template is used to represent the current CU. The corresponding templates of candidates in IBC merge candidate list will be generated and compared with the left template, and the one with smallest SAD/SATD cost will be selected to generate the second predictor. The final predictor of current CU is generated by blending the first and the second predictor.

In some embodiments, the top and left templates of the current block are used to represent (or as the current template of) the current CU. The corresponding templates of candidates in IBC merge candidate list will be generated and compared with the current top and left template, and the one with smallest SAD/SATD cost will be selected to generate the first predictor. And the one with second smallest SAD/SATD cost will be selected to generate the second predictor. After that, the final predictor of current block is generated by blending the first and the second predictor. In some other embodiment, top N candidates with smallest SAD/SATD costs can be used to generate the final predictor. N can be any integer larger than zero. A syntax ibc_subblock_blend_pred_num can be signaled to indicate how many predictors are used during blending.

In some embodiments, template matching can be used to derive the predictor for IBC coded block. First, the top template and left template of current block is used to represent (or as the current template of) the current CU. The corresponding templates of candidates in IBC merge candidate list will be generated and compared with the current top template and left template, and the one with smallest SAD/SATD cost will be selected to generate the first predictor. In the next step, the templates around first predictor are generated. In that, the one with smallest SAD/SATD cost will be selected as the second predictor. The final predictor is generated by blending the first predictor and the second predictor. For example, if the corresponding MV of first predictor is MV_1, the candidate list of second predictor can be [MV_1+MVD1, MV_1+MVD2, MV_1+MVD3, MV_1+MVD4]. MVDN can be any integer pixel (i.e., MVDN=1, 4, 8, −4, −8). For another example, MVDN can be designed based on MV precision, CU size, CU width, or CU height.

In some embodiments, template matching can be used to derive the predictor for IBC coded block. First, the top template of current block is used to represent (or as the current template of) the current CU. The corresponding templates of candidates in IBC merge candidate list will be generated and compared with current top template, and the one with smallest SAD/SATD cost will be selected to generate the first predictor. In the next step, the left template is used to represent current CU. The corresponding templates around first predictor are generated to calculate the TM cost with the current left template. The one with smallest SAD/SATD cost will be selected to generate the second predictor. The candidates of second predictor can be derived by a predefined MV list generated by the first derived motion. For example, if the corresponding MV of first predictor is MV_1, the candidate list of second predictor can be [MV_1+MVD1, MV_1+MVD2, MV_1+MVD3, MV_1+MVD4]. MVDN can be any integer pixel (i.e., MVDN=1, 4, 8, −4, −8). For another example, MVDN can be designed based on MV precision, CU size, CU width, or CU height.

In some embodiments, a position-based weighting can be applied to the above-mentioned IBC-TM-based-multi-predictor mode. For example, samples closed to the top boundary will be applied with larger weightings on the first predictor that is derived by the top template. Samples closed to the left boundary will be applied with larger weightings on the second predictor that is derived by left template.

In some embodiments, the above-mentioned IBC-TM-based-multi-predictor mode can be extended to be subblock-based. For example, in FIG. 13A, templates a and b are used to represent (as templates for) sub-CU A, and templates b and c are used to represent sub-CU B. For another example, in FIG. 13B, templates a and b are used to represent sub-CU A, and templates a and c are used to represent sub-CU B.

The above-mentioned IBC subblock TM merge mode syntax design can also be performed with IBC-TM-based multi-predictor mode or IBC-TM-based-subblock-multi-predictor mode.

n. IBC with Subblock OBMC

Overlapped block motion compensation (OBMC) is a video coding tool that reduces blocking artifact by refining top and left boundary pixels of a CU by using neighboring block's motion information with a weighted prediction, specifically:

Inter′_{predY}=((128−w₁)×Inter_{predY}−w₁×OBMC_{predY})/128

PredY=((4−w₀)×FwdMap(Inter′_{predY})+w₀×Intra_{predY})/4

where Inter_{predY} represents the samples predicted by the motion of current block in the original domain, Intra_{predY} represents the samples predicted in the mapped domain, OBMC_{predY} represents the samples predicted by the motion of neighboring blocks in the original domain, and w₀ and w₁ are the weights.

A subblock-boundary OBMC is performed by applying the same blending to the top, left, bottom, and right subblock boundary pixels using neighboring subblocks' motion information. OBMC maybe enabled for the subblock based coding tools such as Affine AMVP modes, Affine merge modes and subblock-based temporal motion vector prediction, and subblock-based bilateral matching.

In some embodiments, if IBC subblock mode is applied, the subblock boundary can be refined by OBMC. The weighting value or blending lines for IBC subblock mode can be different from inter OBMC. For example, for a block coded in IBC-subblock mode, the blending line numbers may be subblock-size dependent. In some embodiments, a flag is signaled to indicate the on-off of IBC with subblock OBMC. In some embodiments, templates used for subblock OBMC can be left, top, or both left and top templates. After testing three types, the one with smallest per-sample TM cost may be selected and used to refine the predictor.

Any of the foregoing proposed methods can be implemented in encoders and/or decoders. For example, any of the proposed methods can be implemented in predictor derivation module of an encoder, and/or a predictor derivation module of a decoder. Alternatively, any of the proposed methods can be implemented as a circuit coupled to the predictor derivation module of the encoder and/or the predictor derivation module of the decoder, so as to provide the information needed by the predictor derivation module.

### XII. Example Video Encoder

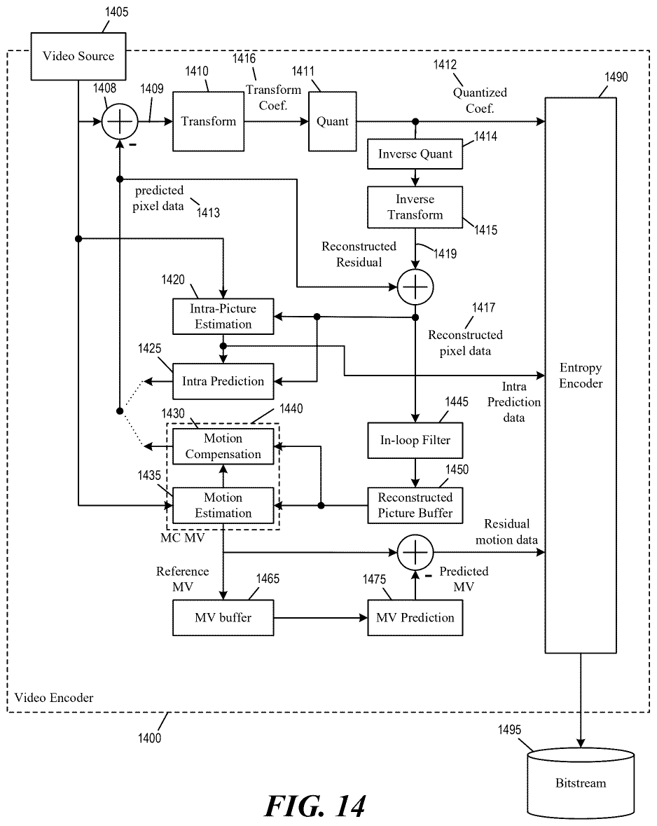

FIG. 14 illustrates an example video encoder 1400 that may implement subblock-based IBC or intraTMP modes. As illustrated, the video encoder 1400 receives input video signal from a video source 1405 and encodes the signal into bitstream 1495. The video encoder 1400 has several components or modules for encoding the signal from the video source 1405, at least including some components selected from a transform module 1410, a quantization module 1411, an inverse quantization module 1414, an inverse transform module 1415, an intra-picture estimation module 1420, an intra-prediction module 1425, a motion compensation module 1430, a motion estimation module 1435, an in-loop filter 1445, a reconstructed picture buffer 1450, a MV buffer 1465, and a MV prediction module 1475, and an entropy encoder 1490. The motion compensation module 1430 and the motion estimation module 1435 are part of an inter-prediction module 1440.

In some embodiments, the modules 1410-1490 are modules of software instructions being executed by one or more processing units (e.g., a processor) of a computing device or electronic apparatus. In some embodiments, the modules 1410-1490 are modules of hardware circuits implemented by one or more integrated circuits (ICs) of an electronic apparatus. Though the modules 1410-1490 are illustrated as being separate modules, some of the modules can be combined into a single module.

The video source 1405 provides a raw video signal that presents pixel data of each video frame without compression. A subtractor 1408 computes the difference between the raw video pixel data of the video source 1405 and the predicted pixel data 1413 from the motion compensation module 1430 or intra-prediction module 1425 as prediction residual 1409. The transform module 1410 converts the difference (or the residual pixel data or residual signal 1408) into transform coefficients (e.g., by performing Discrete Cosine Transform, or DCT). The quantization module 1411 quantizes the transform coefficients into quantized data (or quantized coefficients) 1412, which is encoded into the bitstream 1495 by the entropy encoder 1490.

The inverse quantization module 1414 de-quantizes the quantized data (or quantized coefficients) 1412 to obtain transform coefficients, and the inverse transform module 1415 performs inverse transform on the transform coefficients to produce reconstructed residual 1419. The reconstructed residual 1419 is added with the predicted pixel data 1413 to produce reconstructed pixel data 1417. In some embodiments, the reconstructed pixel data 1417 is temporarily stored in a line buffer (not illustrated) for intra-picture prediction and spatial MV prediction. The reconstructed pixels are filtered by the in-loop filter 1445 and stored in the reconstructed picture buffer 1450. In some embodiments, the reconstructed picture buffer 1450 is a storage external to the video encoder 1400. In some embodiments, the reconstructed picture buffer 1450 is a storage internal to the video encoder 1400.

The intra-picture estimation module 1420 performs intra-prediction based on the reconstructed pixel data 1417 to produce intra prediction data. The intra-prediction data is provided to the entropy encoder 1490 to be encoded into bitstream 1495. The intra-prediction data is also used by the intra-prediction module 1425 to produce the predicted pixel data 1413.

The motion estimation module 1435 performs inter-prediction by producing MVs to reference pixel data of previously decoded frames stored in the reconstructed picture buffer 1450. These MVs are provided to the motion compensation module 1430 to produce predicted pixel data.

Instead of encoding the complete actual MVs in the bitstream, the video encoder 1400 uses MV prediction to generate predicted MVs, and the difference between the MVs used for motion compensation and the predicted MVs is encoded as residual motion data and stored in the bitstream 1495.

The MV prediction module 1475 generates the predicted MVs based on reference MVs that were generated for encoding previously video frames, i.e., the motion compensation MVs that were used to perform motion compensation. The MV prediction module 1475 retrieves reference MVs from previous video frames from the MV buffer 1465. The video encoder 1400 stores the MVs generated for the current video frame in the MV buffer 1465 as reference MVs for generating predicted MVs.

The MV prediction module 1475 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 1495 by the entropy encoder 1490.

The entropy encoder 1490 encodes various parameters and data into the bitstream 1495 by using entropy-coding techniques such as context-adaptive binary arithmetic coding (CABAC) or Huffman encoding. The entropy encoder 1490 encodes various header elements, flags, along with the quantized transform coefficients 1412, and the residual motion data as syntax elements into the bitstream 1495. The bitstream 1495 is in turn stored in a storage device or transmitted to a decoder over a communications medium such as a network.

The in-loop filter 1445 performs filtering or smoothing operations on the reconstructed pixel data 1417 to reduce the artifacts of coding, particularly at boundaries of pixel blocks. In some embodiments, the filtering or smoothing operations performed by the in-loop filter 1445 include deblock filter (DBF), sample adaptive offset (SAO), and/or adaptive loop filter (ALF).

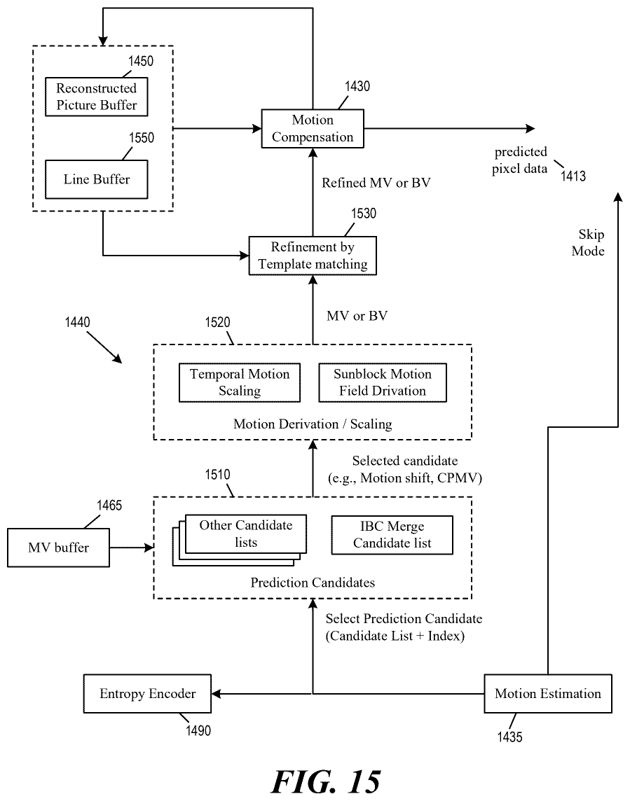

FIG. 15 illustrates portions of the video encoder 1400 that implement subblock-based IBC prediction, including components of the inter-prediction module 1440 of the video encoder 1400. As illustrated, the motion estimation module 1435 provides the selection of a prediction candidate from prediction candidates module 1510. There may be multiple candidate lists for IBC merge mode, subblock-based IBC mode, regular merge mode, etc., respectively. The selection may include a flag to select one candidate list from the multiple candidate lists. The selection may also provide an index to select a particular candidate from the selected candidate list. The selection may also be provided to the entropy encoder 1490 to be signaled in the bitstream 1495, as syntax elements such as ibc_sublk_flag and ibc_sublk_merge_idx.

The prediction candidate module 1510 provide motion information of the selected candidate to a motion derivation and scaling module 1520. The motion derivation and scaling module 1520 may apply such motion information as motion shift for SbTMVP process, or as a CPMV for generating an affine motion field for subblocks of the current block. The motion information may include a MV that references a picture that is temporally different from the current picture, or a BV that references the current picture for IBC or IntraTMP related modes. The motion information may be MV or BV of neighboring blocks or subblocks that are to be averaged to produce a MV or BV for the current block or subblock. The motion derivation and scaling module 1520 may also perform temporal scaling on MVs, or bypass temporal scaling for BVs.

A TM refinement module 1530 may perform template matching operations to refine the MVs and/or BVs generated by the motion derivation and scaling module 1520. A MV or BV may be refined by comparing specific neighboring template regions of the current block or subblock with corresponding regions within a search range located by the MV or BV. The pixel data of the corresponding template may be provided by the reconstructed picture buffer 1450 and/or the line buffer 1550, which stores newly reconstructed pixels. The refined MV or BV is provided to the motion compensation module 1430 to generate the final predictor as the predicted pixel data 1413 for the current block. The motion estimation module 1435 may also provide a skip mode indication to determine whether to generate residual signals.

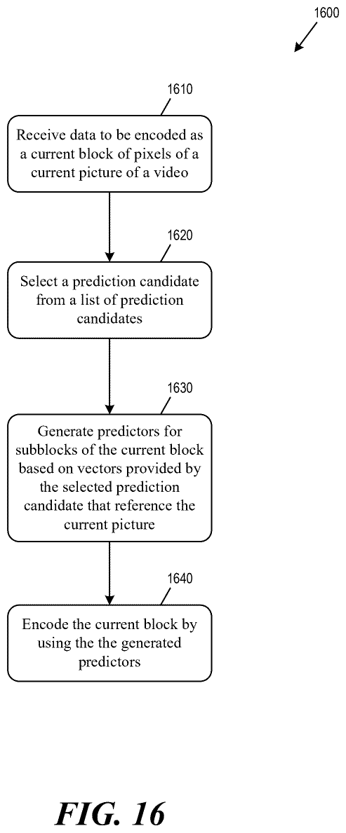

FIG. 16 conceptually illustrates a process 1600 that uses subblock-based IBC modes to encode a block of pixels. In some embodiments, one or more processing units (e.g., a processor) of a computing device implementing the encoder 1400 performs the process 1600 by executing instructions stored in a computer readable medium. In some embodiments, an electronic apparatus implementing the encoder 1400 performs the process 1600.

The encoder receives (at block 1610) data to be encoded as a current block of pixels in a current picture of a video.

The encoder selects (at block 1620) a prediction candidate from a list of prediction candidates. The list of prediction candidates may be a list that is specialized for subblock-based IBC modes, such that the list includes two or more merge candidates that provide predictors for the subblocks of the current block by referencing pixels of the current picture. The encoder may select the prediction candidate by signaling an index for selecting a candidate in the list of prediction candidates (e.g., ibc_sublk_merge_idx), if a flag (e.g., ibc_sublk_flag) for enabling subblock-based IBC is also signaled.

In some embodiments, to implement IBC-sbTMVP mode, one of the prediction candidates in the list provides a block vector that is used to derive motion shift for each subblock of the current block. The motion information of the subblocks of the current block are derived from motion information of corresponding blocks located by the block vector without temporal scaling. In some embodiments, when a center corresponding block located by the block vector is coded by prediction referencing the current picture, the first prediction candidate is duplicated in the list of prediction candidates, one for block-based IBC mode and another for subblock-based IBC mode.

The encoder generates (at block 1630) predictors for subblocks of the current block based on multiple vectors provided by the selected prediction candidate that reference the current picture. The multiple vectors of the subblocks may be an affine motion field derived from vectors associated with corners of the current block. The vectors associated with the corners of the current block may be provided by a merge candidate that references the current picture, or by performing motion searching on the current picture (e.g., IBC AMVP or intraTMP.) In some embodiments, the current block is coded by IBC-STMVP process, in which subblock of the current block is predicted by a motion that is an average of motions of an above neighbor and of a left neighbor, wherein the motion includes a block vector that references the current picture.

In some embodiments, the encoder implements TBC-subblock-TM merge mode, for which the encoder refines predictions of more than one subblocks of the current block based on template regions neighboring the current block. The predictions are based on vectors referencing the current picture. In some embodiments, the encoder implements IBC with subblock OBMC, in which each subblock of the current block is refined along the subblock's boundary based on blending predictions of the subblock and its neighbor, where a number of lines being blended is determined based a size of the subblock.

The encoder encodes (at block 1640) the current block using the generated predictors. In some embodiments, the encoder may signal a skip mode indication for determining whether a residual for the current block is signaled and used for encoding the current block based on the selected prediction candidate, and if skip mode is used then no residual will be generated. In some embodiments, the encoder may apply skip mode to prediction modes that reference the current picture (e.g., IntraTMP) to generate one predictor for the entire current block (i.e., not a subblock mode) without residual, or multiple predictors for multiple subblocks without residual. XII. Example Video Decoder

In some embodiments, an encoder may signal (or generate) one or more syntax element in a bitstream, such that a decoder may parse said one or more syntax element from the bitstream.

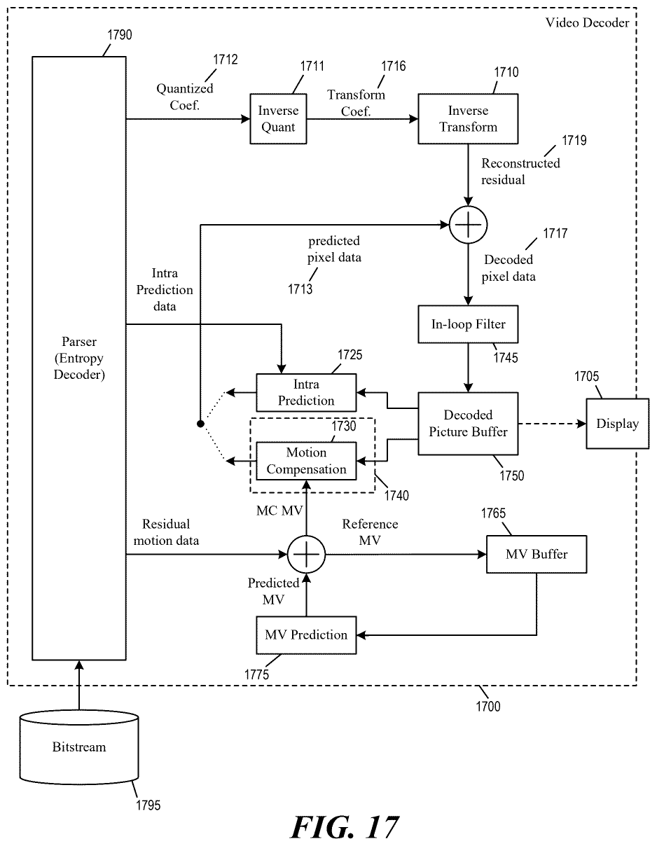

FIG. 17 illustrates an example video decoder 1700 that may implement subblock-based IBC or intraTMP modes. As illustrated, the video decoder 1700 is an image-decoding or video-decoding circuit that receives a bitstream 1795 and decodes the content of the bitstream into pixel data of video frames for display. The video decoder 1700 has several components or modules for decoding the bitstream 1795, including some components selected from an inverse quantization module 1711, an inverse transform module 1710, an intra-prediction module 1725, a motion compensation module 1730, an in-loop filter 1745, a decoded picture buffer 1750, a MV buffer 1765, a MV prediction module 1775, and a parser 1790. The motion compensation module 1730 is part of an inter-prediction module 1740.

In some embodiments, the modules 1710-1790 are modules of software instructions being executed by one or more processing units (e.g., a processor) of a computing device. In some embodiments, the modules 1710-1790 are modules of hardware circuits implemented by one or more ICs of an electronic apparatus. Though the modules 1710-1790 are illustrated as being separate modules, some of the modules can be combined into a single module.

The parser 1790 (or entropy decoder) receives the bitstream 1795 and performs initial parsing according to the syntax defined by a video-coding or image-coding standard. The parsed syntax element includes various header elements, flags, as well as quantized data (or quantized coefficients) 1712. The parser 1790 parses out the various syntax elements by using entropy-coding techniques such as context-adaptive binary arithmetic coding (CABAC) or Huffman encoding.

The inverse quantization module 1711 de-quantizes the quantized data (or quantized coefficients) 1712 to obtain transform coefficients, and the inverse transform module 1710 performs inverse transform on the transform coefficients 1716 to produce reconstructed residual signal 1719. The reconstructed residual signal 1719 is added with predicted pixel data 1713 from the intra-prediction module 1725 or the motion compensation module 1730 to produce decoded pixel data 1717. The decoded pixels data are filtered by the in-loop filter 1745 and stored in the decoded picture buffer 1750. In some embodiments, the decoded picture buffer 1750 is a storage external to the video decoder 1700. In some embodiments, the decoded picture buffer 1750 is a storage internal to the video decoder 1700.

The intra-prediction module 1725 receives intra-prediction data from bitstream 1795 and according to which, produces the predicted pixel data 1713 from the decoded pixel data 1717 stored in the decoded picture buffer 1750. In some embodiments, the decoded pixel data 1717 is also stored in a line buffer (not illustrated) for intra-picture prediction and spatial MV prediction.

In some embodiments, the content of the decoded picture buffer 1750 is used for display. A display device 1705 either retrieves the content of the decoded picture buffer 1750 for display directly, or retrieves the content of the decoded picture buffer to a display buffer. In some embodiments, the display device receives pixel values from the decoded picture buffer 1750 through a pixel transport.

The motion compensation module 1730 produces predicted pixel data 1713 from the decoded pixel data 1717 stored in the decoded picture buffer 1750 according to motion compensation MVs (MC MVs). These motion compensation MVs are decoded by adding the residual motion data received from the bitstream 1795 with predicted MVs received from the MV prediction module 1775.

The MV prediction module 1775 generates the predicted MVs based on reference MVs that were generated for decoding previous video frames, e.g., the motion compensation MVs that were used to perform motion compensation. The MV prediction module 1775 retrieves the reference MVs of previous video frames from the MV buffer 1765. The video decoder 1700 stores the motion compensation MVs generated for decoding the current video frame in the MV buffer 1765 as reference MVs for producing predicted MVs.

The in-loop filter 1745 performs filtering or smoothing operations on the decoded pixel data 1717 to reduce the artifacts of coding, particularly at boundaries of pixel blocks. In some embodiments, the filtering or smoothing operations performed by the in-loop filter 1745 include deblock filter (DBF), sample adaptive offset (SAO), and/or adaptive loop filter (ALF).

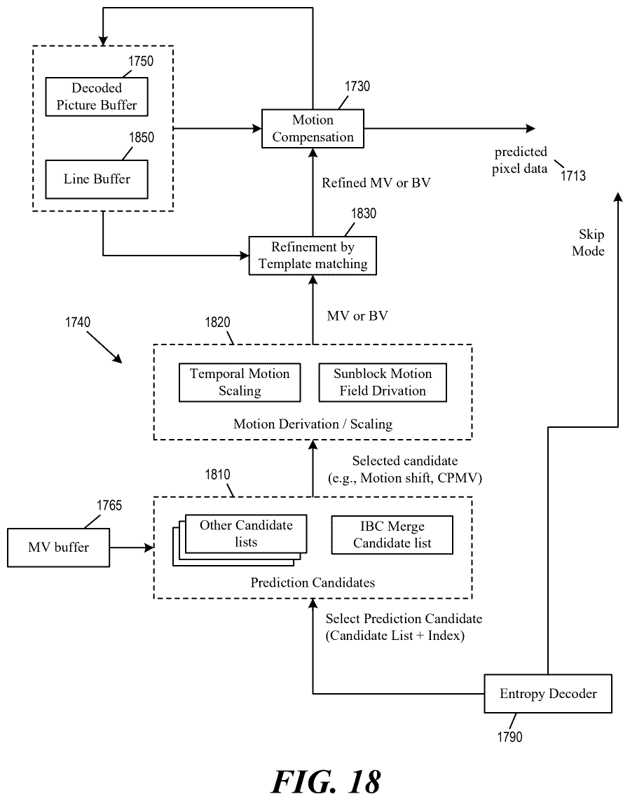

FIG. 18 illustrates portions of the video decoder 1700 that implement subblock-based IBC prediction, including components of the inter-prediction module 1740 of the video decoder 1700. As illustrated, the entropy decoder module 1790 provides the selection of a prediction candidate from prediction candidates module 1810. The selection may be based on syntax elements parsed from the bitstream 1795, such as ibc_sublk_flag and ibc_sublk_merge_idx. There may be multiple candidate lists for IBC merge mode, subblock-based IBC mode, regular merge mode, etc., respectively. The selection may include a flag to select one candidate list from the multiple candidate lists. The selection may also provide an index to select a particular candidate from the selected candidate list.

The prediction candidate module 1810 provide motion information of the selected candidate to a motion derivation and scaling module 1820. The motion derivation and scaling module 1820 may apply such motion information as motion shift for SbTMVP process, or as a CPMV for generating an affine motion field for subblocks of the current block. The motion information may include a MV that references a picture that is temporally different from the current picture, or a BV that references the current picture for IBC or IntraTMP related modes. The motion information may be MV or BV of neighboring blocks or subblocks that are to be averaged to produce a MV or BV for the current block or subblock. The motion derivation and scaling module 1820 may also perform temporal scaling on MVs, or bypass temporal scaling for BVs.

A TM refinement module 1830 may perform template matching operations to refine the MVs and/or BVs generated by the motion derivation and scaling module 1820. A MV or BV may be refined by comparing specific neighboring template regions of the current block or subblock with corresponding regions within a search range located by the MV or BV. The pixel data of the corresponding template may be provided by the decoded picture buffer 1750 and/or the line buffer 1850, which stores newly reconstructed pixels. The refined MV or BV is provided to the motion compensation module 1730 to generate the final predictor as the predicted pixel data 1713 for the current block. The entropy decoder 1790 may also provide a skip mode indication to determine whether to generate residual signals.

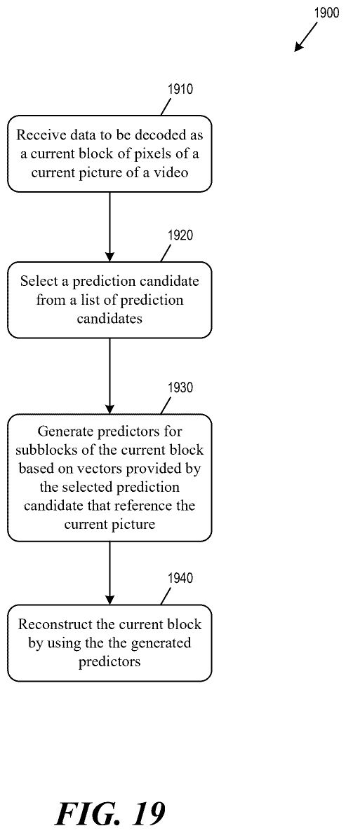

FIG. 19 conceptually illustrates a process 1900 that uses subblock-based IBC modes to decode a block of pixels. In some embodiments, one or more processing units (e.g., a processor) of a computing device implementing the decoder 1700 performs the process 1900 by executing instructions stored in a computer readable medium. In some embodiments, an electronic apparatus implementing the decoder 1700 performs the process 1900.

The decoder receives (at block 1910) data to be decoded as a current block of pixels in a current picture of a video. The decoder selects (at block 1920) a prediction candidate from a list of prediction candidates. The list of prediction candidates may be a list that is specialized for subblock-based IBC modes, such that the list includes two or more merge candidates that provide predictors for the subblocks of the current block by referencing pixels of the current picture. The decoder may select the prediction candidate based on an index received for selecting a candidate in the list of prediction candidates (e.g., ibc_sublk_merge_idx), if a flag (e.g., ibc_sublk_flag) for enabling subblock-based IBC is also received.

In some embodiments, to implement IBC-sbTMVP mode, one of the prediction candidates in the list provides a block vector that is used to derive motion shift for each subblock of the current block. The motion information of the subblocks of the current block are derived from motion information of corresponding blocks located by the block vector without temporal scaling. In some embodiments, when a center corresponding block located by the block vector is coded by prediction referencing the current picture, the first prediction candidate is duplicated in the list of prediction candidates, one for block-based IBC mode and another for subblock-based IBC mode.

The decoder generates (at block 1930) predictors for subblocks of the current block based on multiple vectors provided by the selected prediction candidate that reference the current picture. The multiple vectors of the subblocks may be an affine motion field derived from vectors associated with corners of the current block. The vectors associated with the corners of the current block may be provided by a merge candidate that references the current picture, or by performing motion searching on the current picture (e.g., IBC AMVP or intraTMP.) In some embodiments, the current block is coded by IBC-STMVP process, in which subblock of the current block is predicted by a motion that is an average of motions of an above neighbor and of a left neighbor, wherein the motion includes a block vector that references the current picture.

In some embodiments, the decoder implements IBC-subblock-TM merge mode, for which the decoder refines predictions of more than one subblocks of the current block based on template regions neighboring the current block. The predictions are based on vectors referencing the current picture. In some embodiments, the decoder implements IBC with subblock OBMC, in which each subblock of the current block is refined along the subblock's boundary based on blending predictions of the subblock and its neighbor, where a number of lines being blended is determined based a size of the subblock.

The decoder reconstructs (at block 1940) the current block using the generated predictors. The decoder may provide the reconstructed current block for display as part of the reconstructed current picture.

In some embodiments, the decoder may receive a skip mode indication for indicating whether a residual for the current block is signaled and used for decoding the current block based on the selected prediction candidate, and if skip mode is used then no residual will be applied to reconstruct the current block. In some embodiments, the decoder may apply skip mode to prediction modes that reference the current picture (e.g., IntraTMP) to generate one predictor for the entire current block (i.e., not a subblock mode) without residual, or multiple predictors for multiple subblocks without residual.

### XIV. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

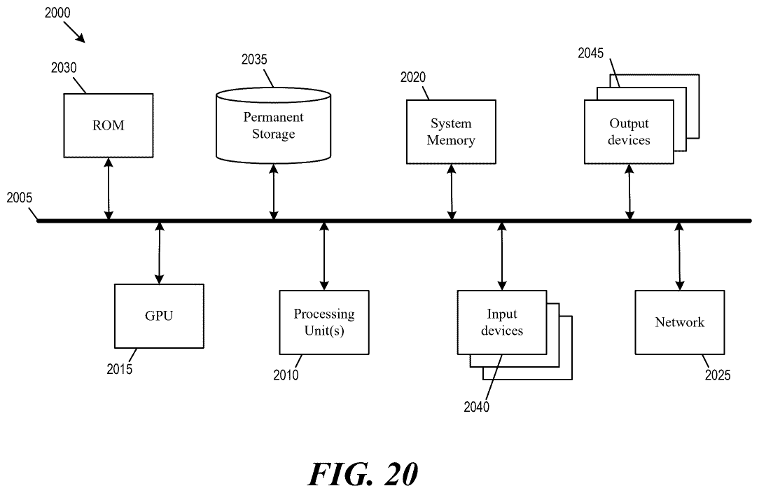

FIG. 20 conceptually illustrates an electronic system 2000 with which some embodiments of the present disclosure are implemented. The electronic system 2000 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 2000 includes a bus 2005, processing unit(s) 2010, a graphics-processing unit (GPU) 2015, a system memory 2020, a network 2025, a read-only memory 2030, a permanent storage device 2035, input devices 2040, and output devices 2045.

The bus 2005 collectively represents all system, peripheral, and chipset buses that communicatively connect the numerous internal devices of the electronic system 2000. For instance, the bus 2005 communicatively connects the processing unit(s) 2010 with the GPU 2015, the read-only memory 2030, the system memory 2020, and the permanent storage device 2035.

From these various memory units, the processing unit(s) 2010 retrieves instructions to execute and data to process in order to execute the processes of the present disclosure. The processing unit(s) may be a single processor or a multi-core processor in different embodiments. Some instructions are passed to and executed by the GPU 2015. The GPU 2015 can offload various computations or complement the image processing provided by the processing unit(s) 2010.

The read-only-memory (ROM) 2030 stores static data and instructions that are used by the processing unit(s) 2010 and other modules of the electronic system. The permanent storage device 2035, on the other hand, is a read-and-write memory device. This device is a non-volatile memory unit that stores instructions and data even when the electronic system 2000 is off. Some embodiments of the present disclosure use a mass-storage device (such as a magnetic or optical disk and its corresponding disk drive) as the permanent storage device 2035.

Other embodiments use a removable storage device (such as a floppy disk, flash memory device, etc., and its corresponding disk drive) as the permanent storage device. Like the permanent storage device 2035, the system memory 2020 is a read-and-write memory device. However, unlike storage device 2035, the system memory 2020 is a volatile read-and-write memory, such a random access memory. The system memory 2020 stores some of the instructions and data that the processor uses at runtime. In some embodiments, processes in accordance with the present disclosure are stored in the system memory 2020, the permanent storage device 2035, and/or the read-only memory 2030. For example, the various memory units include instructions for processing multimedia clips in accordance with some embodiments. From these various memory units, the processing unit(s) 2010 retrieves instructions to execute and data to process in order to execute the processes of some embodiments.

The bus 2005 also connects to the input and output devices 2040 and 2045. The input devices 2040 enable the user to communicate information and select commands to the electronic system. The input devices 2040 include alphanumeric keyboards and pointing devices (also called “cursor control devices”), cameras (e.g., webcams), microphones or similar devices for receiving voice commands, etc. The output devices 2045 display images generated by the electronic system or otherwise output data. The output devices 2045 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 20, bus 2005 also couples electronic system 2000 to a network 2025 through a network adapter (not shown). In this manner, the computer can be a part of a network of computers (such as a local area network (“LAN”), a wide area network (“WAN”), or an Intranet, or a network of networks, such as the Internet. Any or all components of electronic system 2000 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 16 and FIG. 19) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims. Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A video coding method comprising:
receiving data to be encoded or decoded as a current block of pixels of a current picture of a video;
selecting a prediction candidate from a list of prediction candidates,
wherein a first prediction candidate in the list of prediction candidates provides a plurality of vectors that respectively reference a plurality of sets of pixels in the current picture as predictors for a plurality of subblocks of the current block; and
encoding or decoding the current block using the selected prediction candidate.

2. The video coding method of claim 1, further comprising signaling or receiving a skip mode indication for determining whether a residual for the current block is signaled and used for encoding or decoding the current block based on the selected prediction candidate.

3. The video coding method of claim 1, wherein the plurality of vectors of the subblocks are affine motion fields derived from vectors associated with corners of the current block.

4. The video coding method of claim 3, wherein the vectors associated with the corners of the current block are provided by a merge candidate that references the current picture.

5. The video coding method of claim 4, wherein the vectors associated with the corners of the current block are provided by performing motion searching on the current picture.

6. The video coding method of claim 1, wherein the list of prediction candidates comprises two or more merge candidates that provide predictors for the subblocks of the current block by referencing pixels of the current picture.

7. The video coding method of claim 1, further comprising signaling or receiving an index for selecting a candidate in the list of prediction candidates.

8. The video coding method of claim 1, wherein the first prediction candidate provides a block vector, wherein motion information of the subblocks of the current block are derived from motion information of corresponding blocks located by the block vector without temporal scaling.

9. The video coding method of claim 8, wherein when a center corresponding block located by the block vector is coded by prediction referencing the current picture, the first prediction candidate is duplicated in the list of prediction candidates.

10. The video coding method of claim 1, wherein each subblock of the current block is predicted by a motion that is an average of motions of an above neighbor and of a left neighbor, wherein the motion comprises a block vector that references the current picture.

11. The video coding method of claim 1, further comprising refining predictions of more than one subblocks of the current block based on template regions neighboring the current block, wherein the predictions are based on vectors referencing the current picture.

12. The video coding method of claim 1, wherein each subblock of the current block is refined along the subblock's boundary based on blending predictions of the subblock and its neighbor, where a number of lines being blended is determined based a size of the subblock.

13. An electronic apparatus comprising:
a video coder circuit configured to perform operations comprising:
receiving data to be encoded or decoded as a current block of pixels of a current picture of a video;
selecting a prediction candidate from a list of prediction candidates,
wherein a first prediction candidate in the list of prediction candidates provides a plurality of vectors that respectively reference a plurality of sets of pixels in the current picture as predictors for a plurality of subblocks of the current block; and
encoding or decoding the current block using the selected prediction candidate.

14. A video coding method comprising:
receiving data to be decoded as a current block of pixels of a current picture of a video;
selecting a prediction candidate from a list of prediction candidates, wherein the selected candidate in the list of prediction candidates provides a vector that reference a set of pixels in the current picture as a predictor for the current block;
signaling or receiving a skip mode indication for determining whether the current block is to be encoded or decoded without prediction residual; and
encoding or decoding the current block according to the selected prediction candidate and the received skip mode indication.
